(19) United States
(12) Patent Application Publication
(10) Pub. No.: US 2003/0223921 A1
(43) Pub. Date: Dec. 4, 2003

(54) Cylindrical metallic structure for improving catalysis

(75) Inventor: Charles Hsu, Yangmei Cheng (TW)

Correspondence Address: BACON & THOMAS, PLLC, 625 SLATERS LANE, FOURTH FLOOR, ALEXANDRIA, VA, 22314

(73) Assignee: CHARLES HSU, Yangmei Cheng (TW)

(21) Appl. No.: 10/159,256

(22) Filed: Jun. 3, 2002

(51) Int. Cl. B01D 53/34

(52) U.S. Cl. 422/180; 422/177

(57) ABSTRACT

A cylindrical metallic structure for improving catalysis used for rapid activating a catalyst converter comprises a hollow cylindrical shell and an elongate metallic substrate with a flat sheet and a corrugated sheet. Particularly, said elongate metallic substrate is superimposed and rolled up to form a single layer of corrugation structure and a supporting portion, wherein said supporting portion having an upper edge and a lower edge for supporting said single layer of corrugation structure. And said single layer of corrugation structure is located around said supporting portion and contacting with said upper edge and said lower edge. Then, put it into a hollow cylindrical shell for forming said cylindrical metallic structure. This invention is provided for increasing catalyzing area of said metallic structure, and further for improving catalysis of catalyst converters.

### FIELD OF THE INVENTION

The present invention is related to a structure for improving catalysis, particularly, related to a cylindrical metallic structure for improving catalysis of catalyst converters, further for decreasing backpressure of exhaust gas and rapid activating the catalyst converters.

### BACKGROUND OF THE INVENTION

In general, the exhaust gas generated by a gasoline engine is purified with a main honeycombed catalyst converter and an assistant catalyst converter. Please refer to FIGS. 1A and 1B, which illustrate gasoline engines of an automobile and a motorcycle respectively. When the engine 1 of an automobile is operating, the noxious emissions (such as carbon monoxide (CO), hydrocarbons (HC), and nitrogen oxides (NOₓ)) will flow to the main honeycombed catalyst converter 31 (its structure is shown in FIG. 2) through the exhaust pipe 4. Usually, the main honeycombed catalyst converter 31 may exist independently as shown in the FIG. 1A, and the exhaust toxic gas flows through the main honeycombed catalyst converter 31 for catalytic action, changing the noxious emissions, such as carbon monoxide (CO), hydrocarbons (HC), and nitrogen oxides (NOₓ), into non-toxic gas, such as carbon dioxide (CO₂), water (H₂O), and nitrogen (N₂) for purifying the exhausting toxic gas, and then flows out by way of a muffler 3. When the engine 2 of a motorcycle is operating, the noxious emissions (such as carbon monoxide (CO), hydrocarbons (HC), and nitrogen oxides (NOₓ)) will be generated and will flow to the main honeycombed catalyst converter 32 (its structure is shown in FIG. 2) through the exhaust pipe 40. The main honeycombed catalyst converter 32 may be located in a muffler 30 as shown in the FIG. 1B, and the exhaust toxic gas flows through the main honeycombed catalyst converter 32 for catalytic action, changing the noxious emissions, such as carbon monoxide (CO), hydrocarbons (HC), and nitrogen oxides (NOₓ), into non-toxic gas, such as carbon dioxide (CO₂), water (H₂O), and nitrogen (N₂) for purifying the exhausting toxic gas, and being muffled at the same time, then flows out.

Due to the density of the main honeycombed catalyst converter 31 or 32 is very high, referring to the FIG. 2, which means the number of the channel 311a is very high, and the contact area is large, it results in increasing the backpressure and decreasing the engine power. Thus, the main honeycombed catalyst converter 31 or 32 is usually located in the end of the exhaust pipe 4 or 40 respectively, which is far remote away from the engine 1 or 2. The main honeycombed catalyst converter 31 or 32 is made of a substrate having a flat sheet and a corrugated sheet, applied with soldering thereon, superimposed, and rolled up to form a honeycomb structure 31, and then put and fix it into a hollow cylindrical shell 312. However, the main honeycombed catalyst converter 31 or 32 is usually located in the end of the exhaust pipe 4 or 40, which is too far away from the engine 1 or 2 to be activated. The low temperature may cause it difficult to activate the main honeycombed catalyst converter 31 or 32 since the exhaust pipe 4 or 40 is made of steel (generally, the activation temperature is higher than 300° C.), therefore, when the engine 1 or 2 starts to operate at the very beginning, the exhaust gas flows to the main honeycombed catalyst converter 31 or 32 with low temperature, it is very difficult to activate the engine 1 or 2 not only because of the cold steel, but also because of the long distance between the engine 1 or 2 and the main honeycombed catalyst converter 31 or 32. According to the examination of the exhaust gas, most of the exhaust gas pollution is caused by the engine 1 or 2 cold operating and the main honeycombed catalyst converter 31 or 32 being not activated. Thus, it is usually to have an assistant catalyst converter 41 or 42 being located near the engine 1 or 2.

In the prior art, referring to the FIG. 3, the assistant catalyst converter 41 or 42 is made of a hollow cylindrical shell (metallic cylindrical shell) 416 with one layer of catalyst (such as platinum Pt, palladium Pd, and rhodium Rh) applied thereon. Traditionally, the hollow cylindrical shell 416 is placed in front of the exhaust pipe 4 or 40 (near the engine 1 or 2) by solder fixing. The high temperature of the engine 1 or 2 operation and the exothermic reaction of the catalyst acting may reduce the activation time for the main honeycombed catalyst converter 31 or 32 to purify the exhaust gas. However, the contact area of catalysis in the inner wall of the hollow cylindrical shell 412 is small, it cannot provide efficient performance for purification.

Another prior art, referring to the FIG. 4, the assistant catalyst converter 41 or 42 is made of a hollow cylindrical shell (metallic cylindrical shell) 412 and a corrugated alloy foil 411, wherein the corrugated alloy foil 411 is rolled up to insert into the hollow cylindrical shell 412 and fixed by soldering therein, and then, applied with one layer of catalyst (such as platinum Pt, palladium Pd, and rhodium Rh) on the surface of inner wall of the assistant catalyst converter 41 or 42. Though the contact area of catalysis is larger in accordance with the surface of corrugated alloy foil 411, it is more difficult for production and may cause defective. The hollow cylindrical shell 412 and the corrugated alloy foil 411 need to be fixed tightly together, however, it also needs a special tool to insert the corrugated alloy foil 411 into the hollow cylindrical shell 412, thus, it makes the production more difficult and more expansive.

### OBJECT OF THE INVENTION

The main object of the present invention is to provide a cylindrical metallic structure for improving catalysis of catalyst converters by means of increasing the contact area of catalysis.

Another object of the present invention is to provide a metallic structure for reducing the backpressure of the exhaust gas and activating the catalyst action.

The other object of the present invention is to provide a metallic structure to reduce the production cost of the catalyst converters.

### SUMMARY

The present invention provides a cylindrical metallic structure for improving catalysis used for rapid activating a catalyst converter, which comprises a hollow cylindrical shell and an elongate metallic substrate with a flat sheet and a corrugated sheet. Particularly, said elongate metallic substrate is superimposed and rolled up to form a single layer of corrugation structure and a supporting portion, wherein said supporting portion having an upper edge and a lower edge for supporting said single layer of corrugation structure. And said single layer of corrugation structure is located around said supporting portion and contacting with said upper edge and said lower edge. Then, put it into a hollow cylindrical shell for forming said cylindrical metallic structure. This invention is provided for increasing catalyzing area of said metallic structure, and further for improving catalysis of catalyst converters.

### BRIEF DESCRIPTION OF THE DRAWINGS

The present invention will be better understood from the following detailed description of preferred embodiments of the invention, taken in conjunction with the accompanying drawings, in which

FIGS. 1A and 1B are perspective views of gasoline engine of a automobile and a motorcycle respectively;

FIG. 2 is a perspective view of main catalyst converter of a gasoline engine;

FIG. 3 is a perspective view of a conventional assistant catalyst converter of a gasoline engine;

FIG. 4 is a perspective view of another conventional assistant catalyst converter of a gasoline engine;

FIG. 5 is a perspective view of a metallic substrate in accordance with the present invention;

FIG. 6A is an exploded perspective view of a assistant catalyst converter assembly in accordance with the present invention; and

FIG. 6B is a perspective view of a catalyst converter embodying the present invention formed by the procedure of FIG. 3A.

### DESCRIPTION OF THE PREFERRED EMBODIMENTS

The following descriptions of the preferred embodiments are provided to understand the features of the present invention.

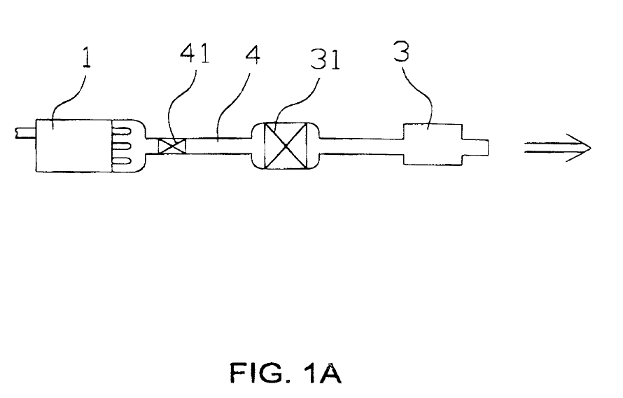

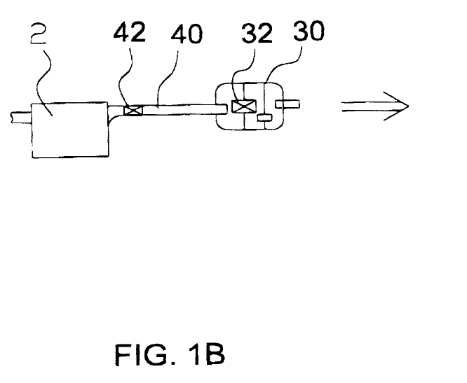

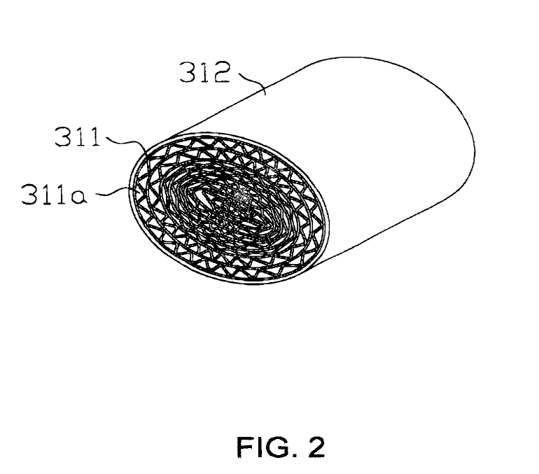

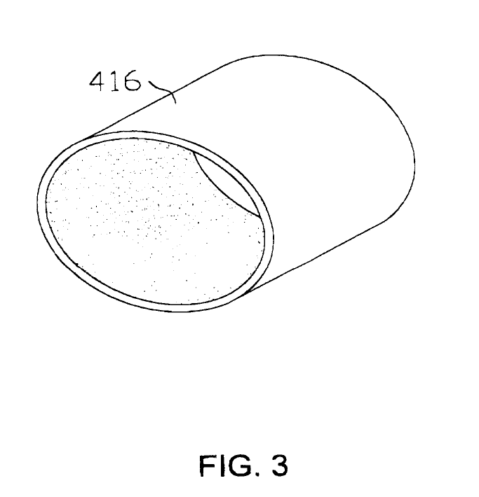

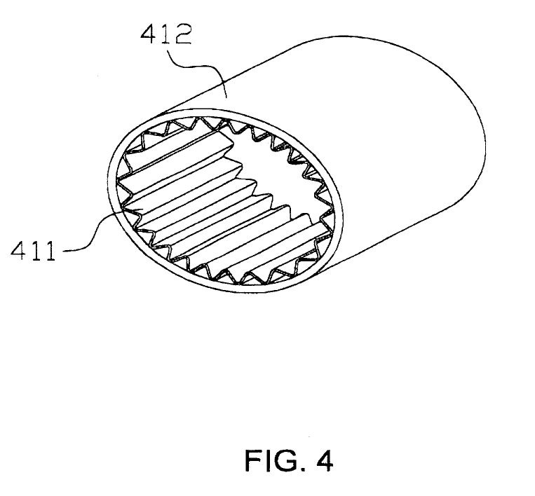

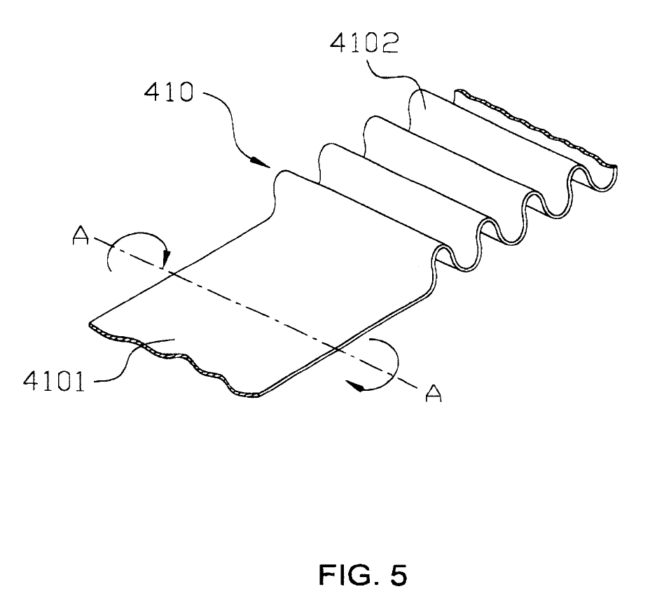

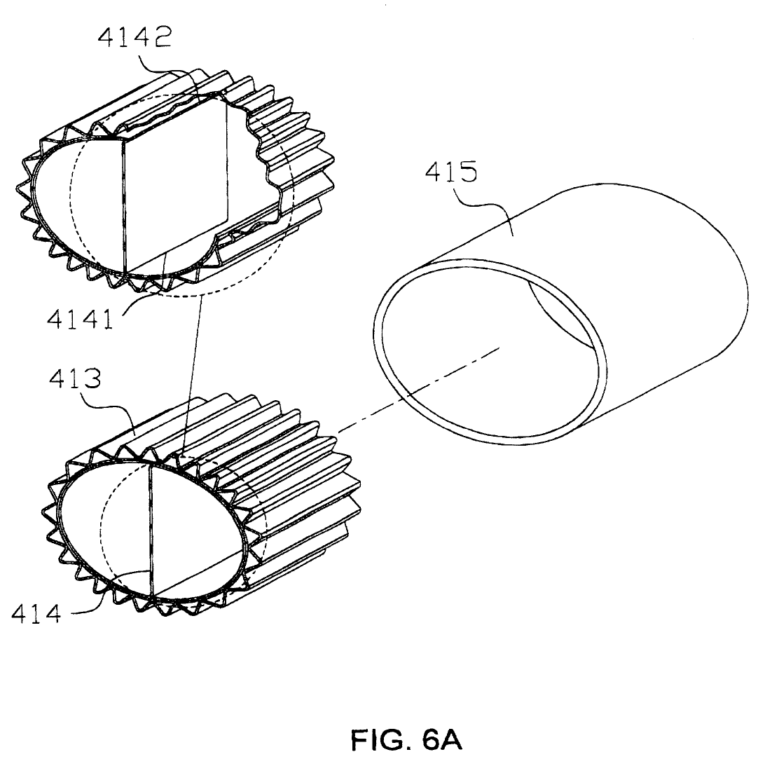

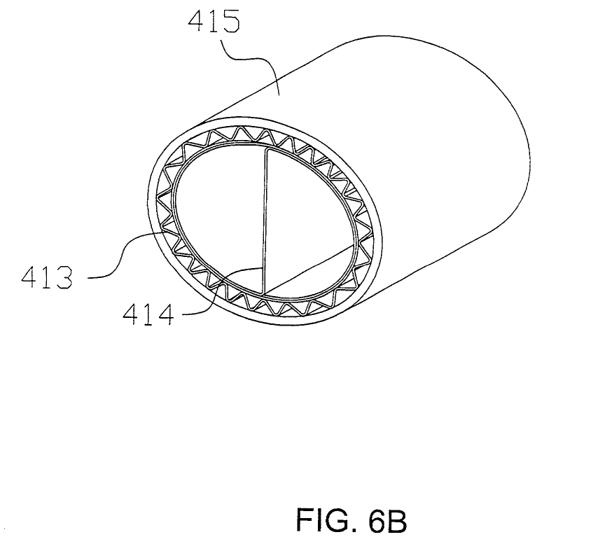

The present invention provides a cylindrical metallic structure for improving catalysis used for rapid activating a main catalyst converter 41 or 42 (shown in the FIG. 1A or FIG. 1B). Referring to the FIG. 5, an elongate metallic substrate 410 having a flat sheet 4101 and a corrugated sheet 4102 is set with a predetermined line A-A. The flat sheet 4101 and the corrugated sheet 4102 having solder applied thereon is superimposed and rolled up from the predetermined line A-A. Next, refer to the FIG. 6A, after the heating process for fixing the solder, it forms a single layer of corrugation structure 413 and a supporting portion 414 having an upper edge 4142 and a lower edge 4141 for supporting the corrugation structure 413. Particularly, said single layer of corrugation 413 is located around said supporting portion 414 and contacting with said upper edge 4142 and said lower edge 4141. The contacting area of catalysis is increasing; therefore, the performance of the catalyst action may increase. Then, the single layer of corrugation structure 413 and the supporting portion 414 insert into a hollow cylindrical shell 415, wherein said hollow cylindrical shell 415 have solder applied thereon. After proper heating process, the cylindrical metallic structure will be formed for improving catalysis of main catalyst converters. The cylindrical metallic structure of this invention is provided for rapid activating catalysis of main catalyst converters (as the catalyst converter 41 or 42 shown in the FIGS. 1A or 1B).

Furthermore, the single layer of corrugation structure 413 comprises one layer of said corrugated sheet 4102 and at least one layer of said flat sheet 4101. This invention increases the contacting area of catalysis (catalyzing area) including the surfaces of the corrugated sheet 4102, the flat sheet 4101, and the supporting portion 414. Therefore, after applying a catalyst (such as platinum Pt, palladium Pd, and rhodium Rh) on the present invention, the main catalyst converter may catalyze efficiently to change the noxious emissions, such as carbon monoxide (CO), hydrocarbons (HC), and nitrogen oxides (NOₓ), into non-toxic gas, such as carbon dioxide (CO₂), water (H₂O), and nitrogen (N₂) for purifying the exhausting toxic gas.

In summation of the foregoing section, this structure, rapid activating a catalyst converter, of the invention herein is an invention of reasonable perfection that not only possesses outstanding practicality, but has an unprecedented structural spatial design that is original and innovative and, furthermore, adapting a larger contact area of catalysis (catalyzing area) with an easy production method to increase the purifying performance that is manifestly capable of increased catalyst converters performance, is a solution to the height characteristics of inventions based on the conventional technology and, furthermore, is progressive and not a conception based merely on familiarity of utilization; therefore, the invention herein fully complies will all new patent application requirements and is hereby submitted to the patent bureau for review and the granting of the commensurate patent rights.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

What is claimed is:

1. A cylindrical metallic structure for improving catalysis used for rapid activating a catalyst converter comprising a hollow cylindrical shell and an elongate metallic substrate with a flat sheet and a corrugated sheet superimposed and rolled up to be put into said hollow cylindrical shell, and the improvement comprises:
a single layer of corrugation structure being formed in accordance with said flat sheet and said corrugated sheet superimposed and rolled up; and
a supporting portion having an upper edge and a lower edge for supporting said single layer of corrugation structure;
wherein said single layer of corrugation structure is located around said supporting portion and contacting with said upper edge and said lower edge for increasing catalyzing area of said metallic structure for rapid activating said catalyst converter.

2. The structure according to claim 1, wherein said single layer of corrugation structure further comprises one layer of said corrugated sheet and at least one layer of said flat sheet.
